(19) United States
(12) Patent Application Publication
(10) Pub. No.: US 2005/0231759 A1
(43) Pub. Date: Oct. 20, 2005

(54) Print management apparatus and print management system incorporating the same

(75) Inventor: Kyoichi Kamijima, Nagano (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/094,482

(22) Filed: Mar. 31, 2005

(30) Foreign Application Priority Data
Mar. 31, 2004 (JP) P2004-107214

(51) Int. Cl. G06F 15/00

(52) U.S. Cl. 358/1.15

(57) ABSTRACT

In a print management apparatus adapted to be connected to a printing apparatus by way of a communication line, a receiver is adapted to receive print data and appendix data including attribute information of the print data, from each of a plurality of client terminals. Allowability information indicative of a condition for allowing the printing of the print data is stored in a storage. The received appendix data is analyzed and it is determined whether the printing of the print data is allowed with reference to the analyzed appendix data and the allowability information. The printing apparatus is caused to execute the printing of the print data when the judge determines that the printing of the print data is allowed.

### BACKGROUND OF THE INVENTION

The present invention relates to a print management system comprising a plurality of client terminals and a print management apparatus which causes a printer to execute printing of print data transmitted from the respective client terminals.

As an example of the above print management system, Japanese Patent Publication No. 10-161823A discloses a print system in which a printer connected to a network is shared among a plurality of users wherein limitations are imposed on printing action by setting usage authorization for each user. In this print system, the usage authorization is managed on a per-user basis through use of a database, and the print data transmitted from a user computer is analyzed by a print server to thus acquire details of printing (e.g., the number of prints, the type of paper, or the like), thereby checking whether or not the details of printing fall within the range of usage authorization, and allowing/prohibiting printing operation according to the results of checking.

Although the above-described print system must acquire details of printing by analyzing print data, the print data are described using different print control languages, according to the manufacturer or type of the printer. There arises a necessity for the print server that analyzes print data to address print data described in various printer control languages. As a result, a mechanism which analyzes print data becomes complicated, and load imposed on an analysis program becomes massive. Particularly, in the case of a machine exclusive to a print server and having a small memory capacity, the load exerted by analysis of the print data becomes serious. Moreover, specifications of the printer control language are often changed in order to add functions or improve performance. Every time the specifications of the printer language are changed, the mechanism for analyzing print data must be modified.

### SUMMARY OF THE INVENTION

It is therefore an object of the invention to provide a printing system in which the print limitations can be appropriately effected on a printer shared in a network.

It is also an object of the invention to provide a printing system in which the print limitations in accordance with print data can be effected regardless of specifications of the print data.

In order to achieve the above objects, according to the invention, there is provided a print management system, comprising:
a plurality of client terminals, each of which is adapted to transmit print data; and
a print management apparatus, adapted to be connected to a printing apparatus by way of a communication line, and to cause the printing apparatus to execute printing of the print data, wherein:
each of the client terminals comprises:
   a converter, which converts a print object file into the print data;
   a generator, which generates appendix data including attribute information of the print data; and
   a transmitter, which transmits the print data and the appendix data to the print management apparatus; and
the print management apparatus comprises:
   a storage, which stores allowability information indicative of a condition for allowing the printing of the print data;
   a receiver, which receives the print data and the appendix data from the transmitter;
   an analyzer, which analyze the received appendix data;
   a judge, which determines whether the printing of the print data is allowed with reference to the analyzed appendix data and the allowability information; and
   a controller, which causes the printing apparatus to execute the printing of the print data when the judge determines that the printing of the print data is allowed.

With this configuration, the determination as to whether the printing of the print data is made with reference to the appendix data which is generated independently from the print data. Accordingly, the determination can be made irrespective of the specification (kind or version of print control language) of the print data.

It is preferable that: the appendix data includes user information indicative of a user of one of the client terminals; the storage stores the allowability information in association with the user information; and the judge refers the allowability information associated with the user information in the appendix data.

Here, the user information may include, in addition to information indicative of the user per se such as a user name, information indicative of a client terminal such as a computer name and an IP address, and information indicative of a group to which the user belongs such as a domain name and a work group name.

It is preferable that: the appendix data includes information indicative of a size of a medium on which the print data is to be printed; the allowability information includes information indicative of a range of an allowable size of the medium; and the judge determines that the printing of the print data is allowed when the size falls within the range of the allowable size.

It is preferable that: the appendix data includes information indicative of a kind of a medium on which the print data is to be printed; the allowability information includes information indicative of a range of an allowable kind of the medium; and the judge determines that the printing of the print data is allowed when the kind falls within the range of the allowable kind.

It is preferable that: the appendix data includes information indicative of an operation mode of the printing to be executed; the allowability information includes information indicative of a range of an allowable operation mode of the printing; and the judge determines that the printing of the print data is allowed when the operation mode falls within the range of the allowable operation mode.

It is preferable that: the appendix data includes information indicative of number of sheets to be printed; the allowability information includes information indicative of a range of an allowable number of sheets to be printed; and the judge determines that the printing of the print data is allowed when the number of sheets to be printed falls within the range of the allowable number of sheets to be printed.

It is preferable that: the storage stores result information indicative of a result of the printing executed by the printing apparatus; and the judges further refers the result information to determine whether the printing of the print data is allowed.

It is preferable that: the generator appends the appendix data to the print data; and the controller transmits the print data to the printing apparatus after deleting the appendix data.

With this configuration, the print data and the appendix data may be included in a single file. Further, since only the print data is transmitted to the printing apparatus, the printing can be executed in such a printing apparatus that is not designed for processing the appendix data.

It is preferable that the appendix data is described with a markup language such as XML. With this configuration, the analyzing operation for the appendix data which is performed in the print management apparatus can be standardized.

According to the invention, there is also provided a storage having recorded a program causing a computer to execute steps of:
converting a print object file into print data;
generating appendix data including attribute information of the print data; and
transmitting the print data and the appendix data to a print management apparatus which is connected to a printing apparatus by way of a communication line, and causes the printing apparatus to execute printing of the print data.

In this case, the computer can serve as a transmitter which transmits the appendix data to be utilized in the print management apparatus.

According to the invention, there is also provided a storage having recorded a program causing a computer, which comprises a converter which converts a print object file into print data, to execute steps of:
generating appendix data including attribute information of the print data; and
transmitting the print data and the appendix data to a print management apparatus which is connected to a printing apparatus by way of a communication line, and causes the printing apparatus to execute printing of the print data.

In this case, the computer can serve as a generator which generates the appendix data to be utilized in the print management apparatus.

According to the invention, there is also provided a print management apparatus adapted to be connected to a printing apparatus by way of a communication line, comprising:
a receiver, adapted to receive print data and appendix data including attribute information of the print data, from each of a plurality of client terminals;
a storage, which stores allowability information indicative of a condition for allowing the printing of the print data;
an analyzer, which analyze the received appendix data;
a judge, which determines whether the printing of the print data is allowed with reference to the analyzed appendix data and the allowability information; and
a controller, which causes the printing apparatus to execute the printing of the print data when the judge determines that the printing of the print data is allowed.

According to the invention, there is also provided a storage having recorded a program causing a computer connected to a printing apparatus by way of a communication line to execute steps of:
receiving print data and appendix data including attribute information of the print data, from each of a plurality of client terminals;
storing allowability information indicative of a condition for allowing the printing of the print data;
analyzing the received appendix data;
determining whether the printing of the print data is allowed with reference to the analyzed appendix data and the allowability information; and
causing the printing apparatus to execute the printing of the print data when the judge determines that the printing of the print data is allowed.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a block diagram showing a print management system according to one embodiment of the invention;

FIG. 2 is a diagram showing an allowable condition table used in the print management system of FIG. 1;

FIG. 3 is a diagram showing a user table used in the print management system of FIG. 1;

FIG. 4 is a flow chart showing a print data transmission processing performed by a client terminal in the print management system of FIG. 1;

FIG. 5 is a diagram showing a data structure of print data and appendix data to be transmitted from the client terminal; and

FIG. 6 is a flow chart showing a processing for judging whether the print data is allowed to be printed, which is executed by a print server in the print management system of FIG. 1.

### DETAILED DESCRIPTION OF THE INVENTION

Embodiments of the invention will be described below in detail with reference to the accompanying drawings.

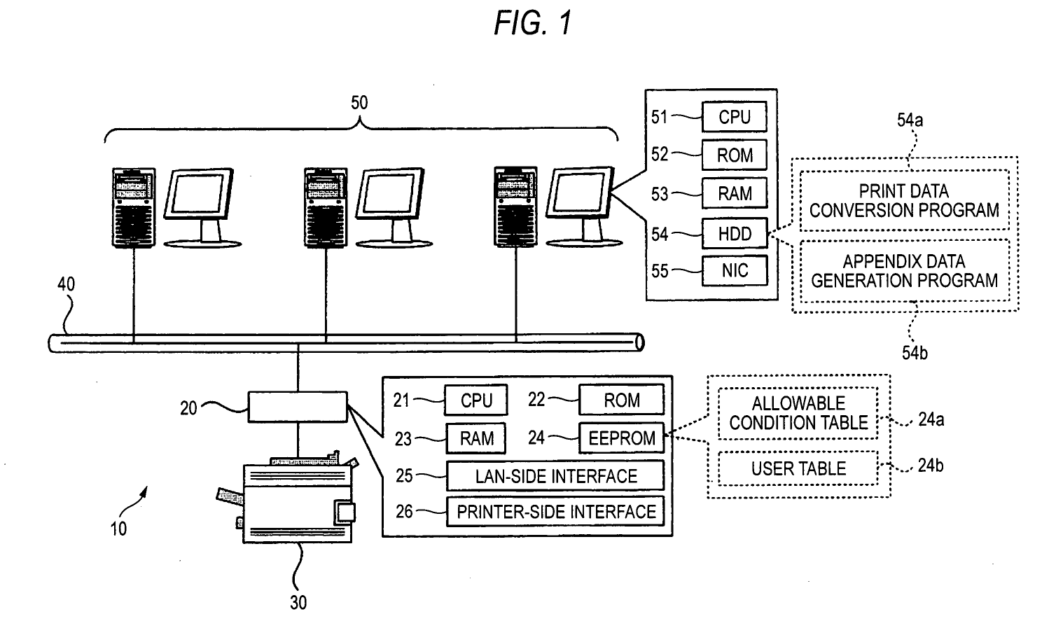

As shown in FIG. 1, a print management system 10 comprises a print server 20 to which a printer 30 is connected; and a plurality of client terminals 50 connected to the print server 20 by way of a LAN 40. Print data transmitted from the respective client terminals 50 are received by the print server 20 and transferred to the printer 30, whereby the printer 30 is shared in the LAN 40.

The print server 20 comprises a CPU 21 for controlling the entire system; a ROM 22 for storing various programs; a RAM 23 for temporarily storing data; and an EEPROM 24 serving as nonvolatile memory. The print server 20 is connected to the LAN 40 by way of a LAN-side interface 25, as well as to the printer 30 by way of a printer-side interface 26. The print server 20 serves as a machine exclusive to a print server which spools the print data transmitted from the respective client terminals 50 and transfers the print data to the printer 30. A USB interface or a Centronics interface (parallel interface) can be mentioned as the printer-side interface 26. Various printers 30 can be connected to the printer-side interface 26, so long as the printers are compatible with the printer-side interface 26.

As illustrated, the EEPROM 24 of the print server 20 has an allowable condition table 24a for managing allowable conditions used for determining whether or not printing of the received print data is allowed; and a user table 24b for managing information about users of the respective client terminals 50.

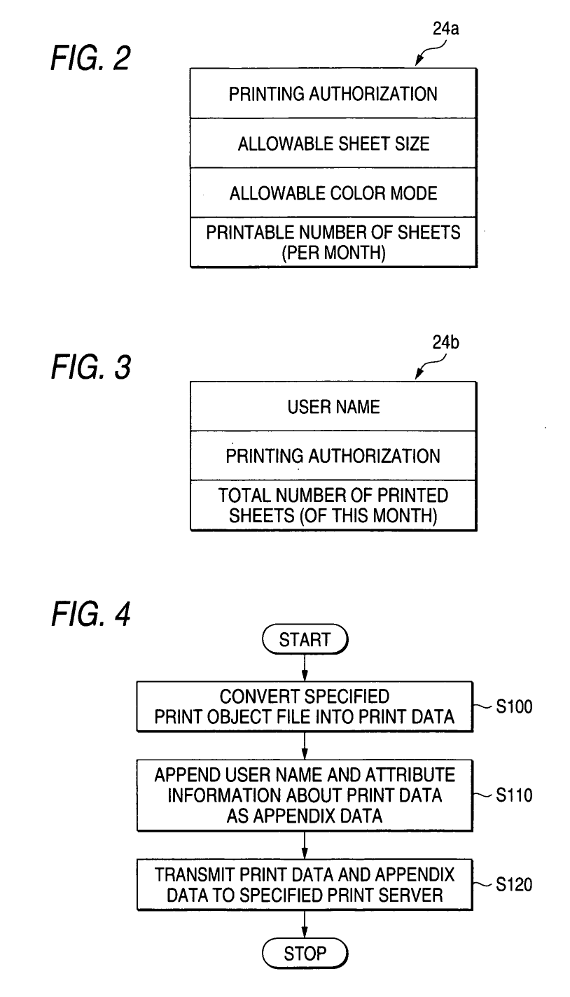

As shown in FIG. 2, the allowable condition table 24a is formed so as to manage information about printing authorization, and a sheet size, a color mode (color printing or monochrome printing), and the number of sheets per month which are allowed for the user given the printing authorization. These information items are registered in advance by an administrator of the print management system 10 through use of management software of the print server 20.

As shown in FIG. 3, the user table 24b is configured to manage information items, such as a user name, printing authorization imparted to the user, and the total number of sheets printed in a month of interest. Of these information items, the user name and the printing authorization have been registered in advance by the administrator of the print management system 10, and the total number of sheets printed is automatically updated when the print server 20 transfers the print data to the printer 30.

As shown in FIG. 1, the client terminal 50 is configured as a non-exclusive computer comprising a CPU 51, a ROM 52, and a RAM 53. The client terminal 50 has a hard disk drive (HDD) 54 which stores data, and a network interface card (NIC) 55 which governs connection to the network. Installed in the HDD 54 are a print data conversion program 54a for converting a print object file, such as an image file or a document file, into print data which can be printed by the printer 30, and an appendix data generation program 54b which generates appendix data, such as attribute information about the converted print data, and transmits the appendix data to the print server 30. Processing pertaining to the print data conversion program 54a and the appendix data generation program 54b will be described later.

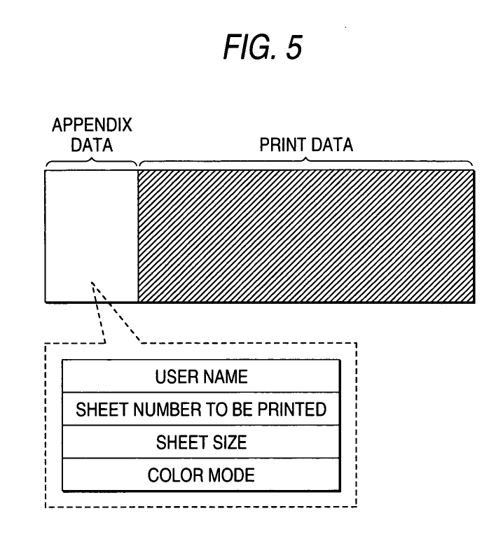

Operation of the thus-constituted print management system 10 will now be described. First, operation of the print management system 10 to be performed when the client terminal 50 transmits print data is described with reference to FIG. 4. This processing is executed by the CPU 51 of the client terminal 50 through use of the print data conversion program 54a and the appendix data generation program 54b. This processing is performed when a command for printing the print object file is issued by way of the application program.

The specified print object file is converted into print data for the printer 30 through print data transmission processing (step S100). Conversion of the file into the print data is performed by performing processing for describing descriptions of the print object file or specified printing conditions (a sheet size or a color mode) through use of the printer control language for the printer 30. Since the processing is the same as that to be performed by a common print driver, further detailed explanations of the processing are omitted.

The user name of the client terminal 50 and the attribute information (including the number of sheets, the sheet size, and the color mode) about the print data is generated as appendix data and appended to the print data (step S110) as shown in FIG. 5. The appendix data and the print data are transmitted to the print server 30 (step S120), whereupon the print data transmission processing is completed.

In this embodiment, XML (extensible Markup Language) is used for describing appendix data for appending the generated appendix data to a leading end of the print data. Here, the user name of the client terminal 50 can be acquired from the operating system (OS) of the client terminal 50 and set. Attribute information about the print data can be set through use of the information acquired when the print object file is converted into the print data in step S100.

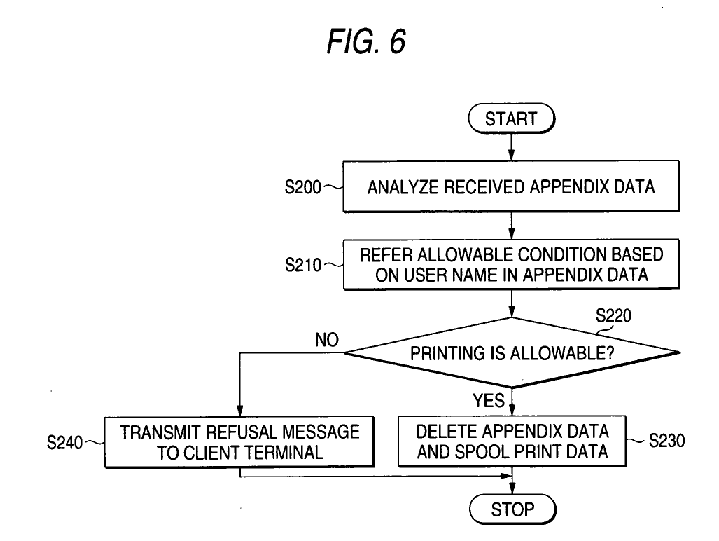

Next, operation of the print server 20 that has received the print data will be described with reference to FIG. 6. This processing is executed by the CPU 21 of the print server 20 when the print data have been received from the client terminal 50. Processing for analyzing the appendix data appended to the leading end of the received print data is first performed (step S200).

Allowable conditions corresponding to the user name of the analyzed appendix data are extracted from the allowable condition table 24a of the EEPROM 24 (step S210). Exaction of the allowable conditions is performed by referring to the print authorization corresponding to the user name of the appendix data in the user table 24b and referring to the allowable conditions associated with the thus-referred printing authorization in the allowable condition table 24a.

When the allowable conditions corresponding to the user name have been extracted, a determination is made as to whether or not printing of the print data is allowed, on the basis of the referred allowable conditions and the attribute information about the appendix data (step S220). Specifically, a determination is made as to whether or not the sheet size and the color mode of the analyzed appendix data fall within the allowable sheet size and the allowable color mode in the allowable conditions, and as to whether or not the sum of the number of sheets to be printed in the analyzed appendix data and the total number of printed sheets in a month of interest in the user table 24b falls within the allowable number of sheets to be printed in the allowable conditions.

When all of the sheet size, the color mode, and the number of sheets to be printed fall within the range of allowable conditions (the allowable sheet size, the allowable color mode, and the allowable number of sheets to be printed), printing of the print data is determined to be allowed. When one or more of the factors fall outside the range of the allowable ranges, printing of the print data is determined to be prohibited. In the present embodiment, when the allowable conditions corresponding to the user name cannot be found (e.g., when the user name is not registered in the user table 24b), printing of the print data is always determined to be prohibited.

When printing is determined to be allowed as a result of the determination, the appendix data appended to the leading end of the print data is deleted, and the print data is spooled in the RAM 23 (step S230). When printing is determined to be prohibited, a refusal message is transmitted to the client terminal 50 (step S240), and the allowability judgment processing is terminated. The print data spooled in the RAM 23 are sequentially transferred to the printer 30, where the data are printed.

With the above configurations, since the allowability of the printing is judged in accordance with the appendix data which is independently generated from the print data for the printer 30, a determination can be made as to whether or not the print data are to be printed, regardless of specifications about the print data (the type and version of the printer control language). The appendix data are described through use of XML, and hence processing for analyzing the appendix data by the print server 20 can be taken as more standard processing. Moreover, when printing is determined to be allowed, the appendix data appended to the leading end of the print data is deleted. Therefore, the present invention can address a conventional printer which is not capable of printing the print data provided with the appendix data.

In the print management system 10 of the embodiment, the user name acquired from the operating system of the client terminal 50 is set as appendix data. Other information may be set as user information about the client terminal 50. Various other types of information items may be set as user information, so long as the information represents a client or a group to which the client belongs, such as an IP address or computer name of the client terminal 50, the name of a work group, or a domain name. In this case, as in the case of the user table 24b, the user information is managed in association with the printing authorization.

In the print management system 10 of the present embodiment, the sheet size, the color mode, and the number of sheets to be printed are illustrated as attribute information about the print data. However, other information may be used as attribute information, so long as the information pertains to descriptions of the print data. For instance, the type of paper may be used as attribute information. In this case, the only requirement is to set the allowable conditions in accordance with attribute information used, to thus determine whether or not printing is allowed. Further, a determination can be made as to whether or not printing of the print data is allowed, by using other types of information as allowable conditions, so long as the information is not attribute information about the print data.

In the print management system 10 of the embodiment, the user table 24b manages the total number of print sheets in a month of interest, and a limitation (printing allowability) is imposed on the number of sheets to be printed per month. However, a limitation may be imposed on printing on the basis of result information other than the total number of printed sheets in a month of interest. For instance, the number of printing operations in a day of interest may be managed, to thus impose a limitation on the number of printing operations per day. Alternatively, no problem arises even when the result information is not performed, such as the total number of printed sheets in a month of interest, or making of a determination as to whether or not printing is allowed on the basis of the management of the result information.

In the print management system 10 of the embodiment, XML is used for describing appendix data. However, as a matter of course, no limitation is imposed on the language used for describing appendix data or the data structure. If the attribute information about the print data can be acquired without analyzing the print data, the additional information may be generated through use of another markup language, any of various types of description languages, or a data structure. Although the appendix data are appended to the leading end of the print data, the method for appending the appendix data is not limited to this method. The appendix data and the print data may be transmitted as separate data files.

In the print management system 10 of the embodiment, when printing is determined to be allowed, the appendix data appended to the leading end of the print data is deleted, and the print data is spooled in the RAM 23. However, the appendix data may be spooled in the RAM 23 in an unmodified manner without being deleted. In this case, the only requirement for the printer 30 is to perform processing such as the printer 30 disregarding the appendix data. Although the print rejection message is described as being transmitted to the client terminal 50 when printing is determined to be prohibited, no problem will arise even when such a print rejection message is not transmitted.

Although the print management system 10 of the embodiment is described as having the allowable condition table 24a and the user table 24b in the EEPROM 24, the information does not need to be managed by the print server 20. For instance, the database server may be installed in the LAN 40 through use of the allowable condition table 24a and the user table 24b. In this case, in the allowability judgment processing, the only requirement is to acquire information, such as the allowable condition corresponding to the user name, from the database server.

In the print management system 10 of the embodiment, the information about the allowable condition and the users of the respective client terminals 50 is described as being managed through use of the allowable condition table 24a and the user table 24. However, the essential requirement is to be able to manage such information. For instance, the allowable sheet size, the allowable color mode, and the allowable number of sheets to be printed may be managed on a per-user basis without managing the printing authorization.

In the print management system 10 of the embodiment, the print server 20 is configured as a machine exclusive to a print server. However, the hardware configuration is not limited to this configuration. For instance, the print server 20 may be configured as a general-purpose computer. Moreover, the print server 20 may be housed in the printer 30.

In the print management system 10 of the embodiment, the client terminal 50 is configured as a general-purpose computer. However, the client terminal may be constituted of a general-purpose computer which performs print data transmission processing pertaining to step S100 and another general-purpose computer which performs processing pertaining to steps S110, S120. Specifically, the print data conversion computer for converting the print object file into print data may be configured as being separate from the appendix data generation computer which generates additional information, such as attribute information about the print data, and transmits the appendix data along with the print data. In this case, the appendix data generation computer may be shared among a plurality of print data conversion computers.

By this configuration, even in the case of the print data generated by the common computer which performs conversion of data solely into print data, the appendix data generation computer generates the appendix data and transmits the print data to the print server 20 while the appendix data are being appended to the print data.

Although the embodiment has described the case where the allowability judgment processing is embodied in the form of the print server 20, the allowability judgment processing illustrated in FIG. 6 is embodied in the form of a print management program to be executed by a single computer or a plurality of computers.

The best mode for carrying out the invention has been described through use of the embodiment. However, the present invention is not limited to such an embodiment and, as a matter of course, can be carried out within the scope of the gist of the invention.

1. A print management system, comprising:
a plurality of client terminals, each of which is adapted to transmit print data; and
a print management apparatus, adapted to be connected to a printing apparatus by way of a communication line, and to cause the printing apparatus to execute printing of the print data, wherein:
each of the client terminals comprises:
a converter, which converts a print object file into the print data;
a generator, which generates appendix data including attribute information of the print data; and
a transmitter, which transmits the print data and the appendix data to the print management apparatus; and
the print management apparatus comprises:
a storage, which stores allowability information indicative of a condition for allowing the printing of the print data;
a receiver, which receives the print data and the appendix data from the transmitter;
an analyzer, which analyze the received appendix data;
a judge, which determines whether the printing of the print data is allowed with reference to the analyzed appendix data and the allowability information; and
a controller, which causes the printing apparatus to execute the printing of the print data when the judge determines that the printing of the print data is allowed.

2. The print management system as set forth in claim 1, wherein:
the appendix data includes user information indicative of a user of one of the client terminals;
the storage stores the allowability information in association with the user information; and
the judge refers the allowability information associated with the user information in the appendix data.

3. The print management system as set forth in claim 1, wherein:
the appendix data includes information indicative of a size of a medium on which the print data is to be printed;
the allowability information includes information indicative of a range of an allowable size of the medium; and
the judge determines that the printing of the print data is allowed when the size falls within the range of the allowable size.

4. The print management system as set forth in claim 1, wherein:
the appendix data includes information indicative of a kind of a medium on which the print data is to be printed;
the allowability information includes information indicative of a range of an allowable kind of the medium; and
the judge determines that the printing of the print data is allowed when the kind falls within the range of the allowable kind.

5. The print management system as set forth in claim 1, wherein:
the appendix data includes information indicative of an operation mode of the printing to be executed;
the allowability information includes information indicative of a range of an allowable operation mode of the printing; and
the judge determines that the printing of the print data is allowed when the operation mode falls within the range of the allowable operation mode.

6. The print management system as set forth in claim 1, wherein:
the appendix data includes information indicative of number of sheets to be printed;
the allowability information includes information indicative of a range of an allowable number of sheets to be printed; and
the judge determines that the printing of the print data is allowed when the number of sheets to be printed falls within the range of the allowable number of sheets to be printed.

7. The print management system as set forth in claim 1, wherein:
the storage stores result information indicative of a result of the printing executed by the printing apparatus; and
the judges further refers the result information to determine whether the printing of the print data is allowed.

8. The print management system as set forth in claim 1, wherein:
the generator appends the appendix data to the print data; and
the controller transmits the print data to the printing apparatus after deleting the appendix data.

9. The print management system as set forth in claim 1, wherein the appendix data is described with a markup language.

10. A storage having recorded a program causing a computer to execute steps of:
converting a print object file into print data;
generating appendix data including attribute information of the print data; and
transmitting the print data and the appendix data to a print management apparatus which is connected to a printing apparatus by way of a communication line, and causes the printing apparatus to execute printing of the print data.

11. A storage having recorded a program causing a computer, which comprises a converter which converts a print object file into print data, to execute steps of:
generating appendix data including attribute information of the print data; and
transmitting the print data and the appendix data to a print management apparatus which is connected to a printing apparatus by way of a communication line, and causes the printing apparatus to execute printing of the print data.

12. A print management apparatus adapted to be connected to a printing apparatus by way of a communication line, comprising:
a receiver, adapted to receive print data and appendix data including attribute information of the print data, from each of a plurality of client terminals;
a storage, which stores allowability information indicative of a condition for allowing the printing of the print data;
an analyzer, which analyze the received appendix data;
a judge, which determines whether the printing of the print data is allowed with reference to the analyzed appendix data and the allowability information; and
a controller, which causes the printing apparatus to execute the printing of the print data when the judge determines that the printing of the print data is allowed.

13. A storage having recorded a program causing a computer connected to a printing apparatus by way of a communication line to execute steps of:
receiving print data and appendix data including attribute information of the print data, from each of a plurality of client terminals;
storing allowability information indicative of a condition for allowing the printing of the print data;
analyzing the received appendix data;
determining whether the printing of the print data is allowed with reference to the analyzed appendix data and the allowability information; and
causing the printing apparatus to execute the printing of the print data when the judge determines that the printing of the print data is allowed.
